(19) United States
(12) Patent Application Publication
(10) Pub. No.: US 2014/0255580 A1
(43) Pub. Date: Sep. 11, 2014

(54) Low Calorie Natural Sweetener

(71) Applicant: Sieto van Dillen, Battle Creek, MI (US)

(72) Inventor: Sieto van Dillen, Battle Creek, MI (US)

(21) Appl. No.: 14/198,719

(22) Filed: Mar. 6, 2014

Related U.S. Application Data
(60) Provisional application No. 61/774,042, filed on Mar. 7, 2013.

(51) Int. Cl. A23L 1/236

(52) U.S. Cl. CPC A23L 1/2364
USPC 426/548

(57) ABSTRACT

The present invention provides a composition containing stevia and a carrier containing both xylitol and erythritol which has the sweet flavor of stevia without a bitter after taste.

### CROSS-REFERENCE TO RELATED APPLICATION

This application claims priority to and all benefits of U.S. Provisional Application 61/774,042, filed on Mar. 7, 2013, entitled “A Low Calorie Natural Sweetener”, which is incorporated herein by reference.

### FIELD OF THE INVENTION

This invention provides a natural low calorie sweetener which overcomes the taste deficiencies of currently available sweeteners.

### BACKGROUND OF THE INVENTION

There are a number of intensely sweet, low calorie natural sweeteners available to replace sucrose in foods and beverage. However, when these sweeteners are compared to natural sugar they suffer from taste deficiencies. Many attempts have been made to overcome these deficiencies. However, in spite of these efforts many people find the low calorie sweeteners unsatisfactory and prefer natural sugar as a sweetener. Among the commonly observed deficiencies are artificial taste, unpleasant aftertaste, and lack of proper mouthfeel. Often sugar alcohols, such as uitol, iso alt mannitol, sorbitol, and xylitol are added to improve mouthfeel of the sweetener. In addition to improving mouthfeel the sugar alcohols also provide sweetness to the product.

Recently, extracts from the stevia rebaudiana plant have been introduced as low calorie natural sweeteners. The sweet properties of such extracts have been known for some time.

U.S. Pat. No. 4,082,858 relates to a sweetening compound recovered from Stevia rebaudiana plant material in the form of colorless crystals having 450 times the sweetness of sucrose. Sweetened products for oral ingestion are provided by admixing the sweetening compound with a foodstuff or a pharmaceutical. The sweetening compound is recovered from the plant material by extraction with water, concentration, extraction with an alkanol, chromatography, and collection of fractions rich in the compound, preferably followed by concentration of the rich fractions and recrystallization of the product.

U.S. Pat. No. 7,964,232 relates to steviol glycoside isomers of rebaudioside A, and to food and beverage products containing the steviol glycoside isomers. The food and beverage products may also contain a sweetener selected from the group consisting of a steviol glycoside, stevia rebaudiana extracts, Lo Han Guo, Lo Han Guo juice concentrate, Lo Han Guo powder, mogroside V, thaumatin, monellin, brazzein, monatin, erythritol, tagatose, sucrose, liquid sucrose, fructose, liquid fructose, glucose, liquid glucose, high fructose corn syrup, invert sugar, medium invert sugar, maple syrup, maple sugar, honey, chicory syrup, agave syrup, brown sugar molasses, cane molasses, sugar beet molasses, sorghum syrup, sorbitol, mannitol, maltitol, xylitol, glycyrrhizin, malitol, maltose, lactose, xylose, arabinose, isomalt, lactitol, trehalulose, ribose, fructo-oligosaccharides, aspartame, neotame, alitame, sodium saccharin, calcium saccharin, acesulfame potassium, sodium cyclamate, calcium cyclamate, neohesperidin dihydrochalcone, sucralose, polydextrose, and mixtures of any of them.

U.S. Pat. No. 7,927,623 relates to a rapidly disintegrating tablet which includes water soluble saccharides water-soluble saccharide selected from the group consisting of mannitol, xylitol, erythritol, maltitol, sorbitol and lactose, and may optionally include a sweetening agent selected from the group consisting of saccharine, aspartame and stevia.

U.S. Pat. No. 6,187,336 relates to a process for making a composition consisting essentially of 80 to 99.9% by weight of erythritol, a component selected from the group consisting of a drug, a pharmaceutically acceptable additive, a food, and a food additive, and moisture in an amount of 5 to 20% by weight based on the solid content of the composition, wherein said pharmaceutically acceptable additive is selected from the group consisting of sucrose, lactose, xylitol, D-mannitol, maltitol, lactitol, magnesium stearate, calcium stearate, talc, light silicic acid anhydride, silicon dioxide hydrate and a surfactant. The composition may optionally include a sweetener such as stevioside, rebaudioside and enzyme-treated stevia.

Published US Patent Application 2011/0027445 relates to a no-calorie or low calorie sweetener compositions comprising a sugar alcohol, such as xylitol, sucralose, and a carbohydrate carrier such as dextrose/maltodextrin.

Published US Patent application 2011/0195130 relates to a food product which may contain a sweetener is selected from the group consisting of: table sugar, brown sugar, sugar syrups, honey, corn syrup, high fructose corn syrup, hydrogenated glucose syrups, turbinado, xylose, ribose, sucrose, mannose, galactose, fructose, dextrose, maltose, polydextrose, aspartame, saccharin, a combination of aspartame, dextrose, and maltodextrin, sucralose, glycol, glycerol, erythritol, threitol, arabitol, xylitol, ribiol, mannitol, sorbitol, dulcitol, iditol, isomalt syrup, high fructose corn syrup, corn syrup and maltitol syrup stevia, acesulfame potassium, and combinations thereof.

Commercially stevia is available in compositions having various carriers such as erythritol. Many people find that these products have an objectionable bitter after taste. Accordingly, there is a need for a product which has stevia's sweet flavor without the objectionable bitter after taste.

### SUMMARY OF THE INVENTION

It has now been found that a composition containing stevia and a carrier containing both xylitol and erythritol has the sweet flavor of stevia without the objectionable bitter stevia after taste. Neither xylitol or erythritol alone mask the after taste of stevia. The masking of the after taste requires the presence of both xylitol, and erythritol in the carrier. The combination of stevia, xylitol, and erythritol produce a free flowing composition which matches the taste and mouthfeel of sucrose without any flavor potentiators.

### DETAILED DESCRIPTION OF THE INVENTION

There are several stevia containing sweeteners on the market. Stevia is 250 to 300 times as sweet as sucrose. The weight of stevia which would be equivalent to a teaspoon of sucrose would be about 13 to 16 milligrams. This is far too small a quantity to measure conveniently when stevia sweeteners are used as a substitute for sucrose in baking or sweetening a cup of coffee. Accordingly the stevia sweetener products on the market all contain stevia and some sort of carrier. Sugar alcohols such as xylitol and erythritol are often used as carriers.

Many people find that stevia has an initially sweet flavor, but a lingering unpleasant bitter after taste. This aftertaste seems to be characteristic of stevia itself. Although the sugar alcohols diminish unpleasant aftertaste of stevia but do not entirely eliminate it. Compositions containing stevia and a xylitol carrier or stevia and an erythritol carrier have the unpleasant stevia aftertaste.

It has now been found that a composition containing stevia and a carrier containing both xylitol and erythritol in, specific ratios, has the sweet flavor of stevia without the objectionable bitter stevia after taste. Control of the stevia aftertaste requires the presence of both xylitol, and erythritol in the carrier. Neither xylitol nor erythritol alone remove the aftertaste of stevia. The combination of stevia, xylitol, and erythritol produce a free flowing composition which matches the taste and mouthfeel of sucrose without any flavor potentiators. When formulated correctly the composition matches sugar on a volume for volume or weight for weight basis.

A gram of erythritol is about 70% as sweet as a gram of sucrose. Xylitol is approximately as sweet as sucrose. As noted above, stevia is 250 to 300 times as sweet as sucrose. Thus, when stevia is formulated with xylitol or erythritol carriers, a portion of the sweetness of the composition is contributed by the carrier. Since xylitol is as sweet as sucrose, the addition of stevia to pure xylitol will make the composition sweeter than xylitol, and thus sweeter than sucrose. Accordingly, a pure xylitol carrier can not be used to create a composition which is as sweet as sucrose on a weight basis. When a mixture of xylitol and erythritol are used as a carrier the sweetness of the carrier is less than the sweetness of an equivalent amount of sucrose. To obtain a composition which matches the sweetness of sucrose on a weight basis stevia is added to add the sweetness which erythritol does not provide.

In order to mask the unpleasant taste of stevia the carrier should contain both erythitol and xylitol. Depending upon the taste and sweetness desired and caloric considerations, the quantity of stevia may vary from 0.1% of the carrier weight to 5% of the carrier weight, with the ideal range from 0.25% to 1%. The composition of the carrier which will mask the bitter taste after taste of stevia varies depending upon the amount of stevia. When stevia is present at a level of 0.25% to 1% of the total carrier weight, a carrier containing from 20 weight % to 90 weight % erythritol and 10 weight % to 80 weight % xylitol serves to mask the bitter after taste of stevia. When stevia is present at a level of 5% of the total carrier weight, a carrier containing from 42 weight % to 58 weight % erythritol and 42 weight % to 58 weight % xylitol serves to mask the bitter after taste of stevia. The carrier compositions which will mask the bitter stevia aftertaste, for several concentrations of stevia, are shown in Table 1. All percentages are weight percent.

TABLE 1

| Stevia as % of | Erythritol % of | Xylitol % of |
|---|---|---|
| carrier weight | carrier weight | carrier weight |
| 0.25-1.0% | 20%-90% | 10%-80% |
| 2.0% | 25%-82% | 18%-75% |
| 3.0% | 31%-74% | 26%-69% |
| 4.0% | 36%-66% | 34%-64% |
| 5.0% | 42%-58% | 42%-58% |

For compositions having between 0.25% and 1% stevia as a percentage of the total carrier weight a carrier containing 20-90 weight percent erythritol and 10-80 weight percent xylitol is able to mask the bitter stevia after taste. For compositions containing between 1 and 5% stevia as a percentage of the total carrier weight, the appropriate carrier composition to mask the stevia after taste varies with the amount of stevia present. The range of erythritol in the erythritol/xylitol carrier may be calculated using the following equations. The upper end of the range of erythritol amounts is:

E%=55−1.25(X−1)+[35−6.75(X−1)].

The lower end of range of erythritol amounts is:

E%=55−1.25(X−1)−[35−6.75(X−1)].

Where X is the amount of stevia as a percentage of the total carrier weight and E% is the weight percent of erythritol in the carrier. Xylitol makes up the reminder of the carrier. The percentage of erythritol and xylitol in the carrier, found from the equations above, are rounded to whole numbers.

### EXAMPLE I

Several compositions containing xylitol, erythritol and erythritol were prepared. The compositions had different carriers, but each sample contained stevia at a level of 0.3% of the total carrier weight. They were tested for taste and physical characteristics. In the chart below the percentages are given as percent of the total carrier weight, not the percentage of the total composition weight. The weight of the stevia is small and thus there is little difference between the percentage of carrier weight and the percentage of total composition weight. Samples 1, 2, and 11 are comparison samples. Samples 3, 4, 5, 6, 7, 8, 9 and 10 are examples of the invention. Sample 3 is slightly less sweet than sugar.

| | Erythritol | Xylitol | Stevia | | | |
|---|---|---|---|---|---|---|
| Sample # | Grams (%) | Grams (%) | Grams (%) | First Taste | After Taste | Characteristics |
| 1 | 100 (100%) | 0 (0%) | 0.3 (0.3%) | Semi sweet | Bitter | Cooling effect |
| 2 | 0 (0.0%) | 100 | 0.3 (0.3%) | Honey Sweet | Bitter | Honey flavor |
| 3 | 90 (90%) | 10 (10%) | 0.3 (0.3%) | Semi sweet | None | Cooling effect |
| 4 | 80 (80%) | 20 (20%) | 0.3 (0.3%) | Sweet | None | Cooling effect |
| 5 | 70 (70%) | 30 (30%) | 0.3 (0.3%) | Sweet | None | Sugar like |
| 6 | 60 (60%) | 40 (40%) | 0.3 (0.3%) | Sweet | None | Sugar like |
| 7 | 50 (50%) | 50 (50%) | 0.3 (0.3%) | Sweet | None | Sugar like |
| 8 | 40 (40%) | 60 (60%) | 0.3 (0.3%) | Sweet | None | Sugar like |
| 9 | 30 (30%) | 70 (70%) | 0.3 (0.3%) | Sweet | None | Sugar like |
| 10 | 20 (20%) | 80 (80%) | 0.3 (0.3%) | Honey Sweet | None | Sugar honey mix |
| 11 | 10 (10%) | 90 (90%) | 0.3 (0.3%) | Honey Sweet | Mild Bitter | Sugar honey mix |

### EXAMPLE II

Several compositions containing xylitol, erythritol and erythritol were prepared. The compositions had different carriers, but each sample contained stevia at a level of 1% of the total carrier weight. They were tested for taste and physical characteristics. In the chart below the percentages are given as percent of the total carrier weight not the percentage of the total composition weight. Samples 1, 2, and 11 are comparison samples. Samples 3, 4, 5, 6, 7, 8, 9 and 10 are examples of the invention.

| | | Xylitol | Stevia | | | |
|---|---|---|---|---|---|---|
| Sample | Erythritol | Grams | Grams | First | After | |
| # | Grams (%) | (%) | (%) | Taste | Taste | Characteristics |
| 1 | 100 (100%) | 0 (0%) | 1 (1%) | Semi sweet | Bitter | Cooling effect |
| 2 | 0 (0.0%) | 100 (100%) | 1 (1%) | Intense Honey | Bitter | Honey flavor |
| | | | | Sweet | | |
| 3 | 90 (90%) | 10 (10%) | 1 (1%) | Sweet | None | Cooling effect |
| 4 | 80 (80%) | 20 (20%) | 1 (1%) | Intense Sweet | None | Cooling effect |
| 5 | 70 (70%) | 30 (30%) | 1 (1%) | Intense Sweet | None | Sugar like |
| 6 | 60 (60%) | 40 (40%) | 1 (1%) | Intense Sweet | None | Sugar like |
| 7 | 50 (50%) | 50 (50%) | 1 (1%) | Intense Sweet | None | Sugar like |
| 8 | 40 (40%) | 60 (60%) | 1 (1%) | Intense Sweet | None | Sugar like |
| 9 | 30 (30%) | 70 (70%) | 1 (1%) | IntenseSweet | None | Sugar like |
| 10 | 20 (20%) | 80 (80%) | 1 (1%) | Intense Honey Sweet | None | Sugar/honey |
| | | | | | | mix |
| 11 | 10 (10%) | 90 (90%) | 1 (1%) | Intense Honey Sweet | Mild | Sugar/honey |
| | | | | | Bitter | mix |

### EXAMPLE III

Several compositions containing xylitol, erythritol and erythritol were prepared. The compositions had different carriers, but each sample contained stevia at a level of 5% of the total carrier weight. They were tested for taste and physical characteristics. In the chart below the percentages are given as percent of the total carrier weight not the percentage of the total composition weight. Samples 1, 2, 3, 4, 5, 9, 10 and 11 are comparison samples. Samples 6, 7, and 8 are examples of the invention.

| | Erythritol | Xylitol | Stevia | | | |
|---|---|---|---|---|---|---|
| Sample | Grams | Grams | Grams | | | |
| # | (%) | (%) | (%) | First Taste | After Taste | Characteristics |
| 1 | 100 (100%) | 0 (0%) | 5 (5%) | Intense Sweet | Intense | Cooling effect |
| | | | | | Bitter | |
| 2 | 0 (0.0%) | 100 (100%) | 5 (5%) | Intense Honey | IntenseBitter | Honey flavor |
| | | | | Sweet | | |
| 3 | 90 (90%) | 10 (10%) | 5 (5%) | Intense Sweet | Bitter | Cooling effect |
| 4 | 79 (79%) | 21 (21%) | 5 (5%) | Intense Sweet | Bitter | Cooling effect |
| 5 | 68 (68%) | 32 (32%) | 5 (5%) | Intense Sweet | Mild | Sugar like |
| | | | | | Bitter | |
| 6 | 58 (58%) | 42 (42%) | 5 (5%) | Intense Sweet | None | Sugar like |
| 7 | 50 (50%) | 50 (50%) | 5 (5%) | Intense Sweet | None | Sugar like |
| 8 | 42 (42%) | 58 (55%) | 5 (5%) | Intense Sweet | None | Sugar like |
| 9 | 32 (32%) | 68 (68%) | 5 (5%) | IntenseSweet | Mild Bitter | Sugar like |
| 10 | 21 (21%) | 79 (79%) | 5 (5%) | Intense Honey | Bitter | Sugar/honey |
| | | | | Sweet | | mix |
| 11 | 11 (11%) | 89 (89%) | 5 (5%) | Intense Honey | Intense | Sugar/honey |
| | | | | Sweet | Bitter | mix |

What is claimed:

1. A composition comprising stevia and a carrier comprising erythritol and xylitol, where the percentage of erythritol in the carrier is in a range
E%=55 1.25(X−1)+[35 6.75(X−1)]
to
E%=55−1.25(X−1)−[35−6.75(X−1)]
where E% is the weight percentage of erythritol in the carrier, X is the amount stevia as a percentage of the total carrier weight, and wherein X is between 1.0% and 5%.

2. A composition according claim 1 comprising a carrier comprising erythritol and xylitol, 1% stevia as a percentage of carrier weight, 20% to 90% erythritol as a percentage of carrier weight, and 10% to 80% Xylitol as a percentage of carrier weight.

3. A composition according claim 1 comprising a carrier comprising erythritol and xylitol, 2% stevia as a percentage of carrier weight, 25% to 82% erythritol as a percentage of carrier weight, and 10% to 80% Xylitol as a percentage of carrier weight.

4. A composition according to claim 1 comprising a carrier comprising erythritol and xylitol, 3% stevia as a percentage of carrier weight, 31% to 74% erythritol as a percentage of carrier weight, and 26% to 69% Xylitol as a percentage of carrier weight.

5. A composition according to claim 1 comprising a carrier comprising erythritol and xylitol, 4% stevia as a percentage of carrier weight, 36% to 66% erythritol as a percentage of carrier weight, and 34% to 64% Xylitol as a percentage of carrier weight.

6. A composition according to claim 1 comprising a carrier comprising erythritol and xylitol, 5% stevia as a percentage of carrier weight, 42% to 58% erythritol as a percentage of carrier weight, and 42%-58% Xylitol as a percentage of carrier weight.

7. A composition comprising a carrier comprising erythritol and xylitol, 0.25% to 1.0% stevia as a percentage of carrier weight, 20% to 90% erythritol as a percentage of carrier weight, and 10% to 80% Xylitol as a percentage of carrier weight.

8. A composition according to claim 7 in which the carrier contains 80% by weight erythritol and 20% by weight xylitol.

9. A composition according to claim 7 in which the carrier contains 70% by weight erythritol and 30% by weight xylitol.

10. A composition according to claim 7 in which the carrier contains 60% by weight erythritol and 40% by weight xylitol.

11. A composition according to claim 7 in which the carrier contains 50% by weight erythritol and 50% by weight xylitol.

12. A composition according to claim 7 in which the carrier contains 40% by weight erythritol and 60% by weight xylitol.

13. A composition according to claim 7 in which the carrier contains 30% by weight erythritol and 70% by weight xylitol.
